(19) United States
(12) Patent Application Publication
(10) Pub. No.: US 2018/0156064 A1
(43) Pub. Date: Jun. 7, 2018

(54) TURBOCHARGER HEAT SHIELD THERMAL BARRIER COATINGS

(71) Applicant: GM GLOBAL TECHNOLOGY OPERATIONS LLC, Detroit, MI (US)

(72) Inventors: Su Jung Han, Bloomfield Twp., MI (US); Julie Swartz, Commerce Twp., MI (US); Louis Begin, Rochester, MI (US); Zhe Li, Rochester, MI (US)

(21) Appl. No.: 15/370,521

(22) Filed: Dec. 6, 2016

(51) Int. Cl. F01D 25/14; F01D 25/24; C04B 35/48; C23C 30/00

(52) U.S. Cl. CPC F01D 25/145; F01D 25/24; C04B 35/48; C23C 30/00; F05D 2300/20; F05D 2240/24; F05D 2300/173; F05D 2300/177; F05D 2220/40

(57) ABSTRACT

Provided herein are thermal barrier coatings (TBC) and turbocharger heat shields comprising the same. The turbocharger heat shield can be metallic and include a front face having an aperture capable of accepting a turbocharger shaft. The TBC can include a bond coat applied to the turbocharger heat shield, an interfacial layer contacting the bond coat, and a ceramic top coat contacting the interfacial layer. The bond coat of the TBC can comprise nickel, at least about 4% aluminum, up to about 36% chromium. One or more of the one or more of the interfacial layer and the ceramic top coat can comprise aluminum oxide, titanium oxide, spinel, yttria-stabilized zirconia, gadolinium zirconate, and combinations thereof. One or more of the interfacial layer and the ceramic top coat can be free from yttria-stabilized zirconia and gadolinium zirconate. The TBC can have a total thickness of at least about 100 μm.

### INTRODUCTION

During a combustion cycle of an internal combustion engine (ICE), air/fuel mixtures are provided to cylinders of the ICE. The air/fuel mixtures are compressed and/or ignited and combusted to provide output torque. Many diesel and gasoline ICEs employ a supercharging device, such as an exhaust gas turbine driven turbocharger, to compress the airflow before it enters the intake manifold of the engine in order to increase power and efficiency. Specifically, a turbocharger is a centrifugal gas compressor that forces more air (i.e., oxygen) into the combustion chambers of the ICE than is otherwise achievable with ambient atmospheric pressure. The additional mass of oxygen-containing air that is forced into the ICE improves the engine's volumetric efficiency, allowing it to burn more fuel in a given cycle, and thereby produce more power.

A typical turbocharger employs a central shaft that transmits rotational motion between an exhaust-driven turbine wheel and an air compressor wheel. Such a shaft is typically supported by one or more bearings in a bearing housing located between an exhaust turbine housing and an air compressor housing. A heat shield can be employed between the exhaust turbine housing and the air compressor housing to improve turbocharger heat management. Heat shields are typically constructed of metal materials (e.g., steel) whose malleability and ductility lend high durability to the heat shields during operation, particularly when utilized in vehicular applications.

### SUMMARY

One or more embodiments provide turbocharger heat shields having thermal barrier coatings (TBC). The turbocharger heat shield can include a front face having an aperture capable of accepting a turbocharger shaft. The TBC can include a bond coat applied to the turbocharger heat shield, an interfacial layer contacting the bond coat, and a ceramic top coat contacting the interfacial layer. As the part in operation, thermally grown oxide (TGO) layer can be grown at the bond coat and top coat interface by further oxidation of bond coat material. The TBC can be applied to a metallic turbocharger heat shield. The metallic turbocharger heat shield can comprise stainless steel. The bond coat of the TBC can comprise nickel, at least about 4% aluminum, and optionally up to about 36% chromium.

In some embodiments, one or more of the one or more of the interfacial layer and the ceramic top coat can comprise aluminum oxide, titanium oxide, spinel, yttria-stabilized zirconia, gadolinium zirconate, and combinations thereof. In some embodiments, one or more of the interfacial layer and the ceramic top coat are free from yttria-stabilized zirconia and gadolinium zirconate. The interfacial layer can comprise a mixture of the ceramic material from the ceramic layer and the bond coat material from the bond coat layer. In some embodiments, the bond coat can have a thickness of at least about 15 μm. In some embodiments, the bond coat and the interfacial layers can have a combined thickness of at least about 50 μm. In some embodiments, the interfacial layer can have a thickness of at least about 10 μm. In some embodiments, the ceramic top coat can have a thickness of at least about 150 μm. In some embodiments, the TBC can have a total thickness of at least about 100 μm.

Although many of the embodiments herein are describe in relation to TBCs used for turbocharger heat shields, the embodiments herein are generally suitable for all heat management applications utilizing heat shields.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 illustrates a schematic perspective view of an engine with a turbocharger, according to one or more embodiments;

FIG. 2 illustrates a schematic cross-sectional view of a turbocharger, according to one or more embodiments.

FIG. 3 illustrates a schematic close-up cross-sectional view of a turbocharger, according to one or more embodiments.

FIG. 4A illustrates a perspective view of a turbocharger heat shield, according to one or more embodiments.

FIG. 4B illustrates a perspective view of a turbocharger heat shield, according to one or more embodiments.

FIG. 5 illustrates thermal conductivity data for a thermal barrier coating, according to one or more embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Provided herein are turbocharger heat shields having thermal barrier coatings (TBC) which impart enhanced heat management to turbochargers ICEs. The heat shields having TBCs increase engine and turbocharger efficiency, and can be utilized in applications beyond turbocharger heat shields.

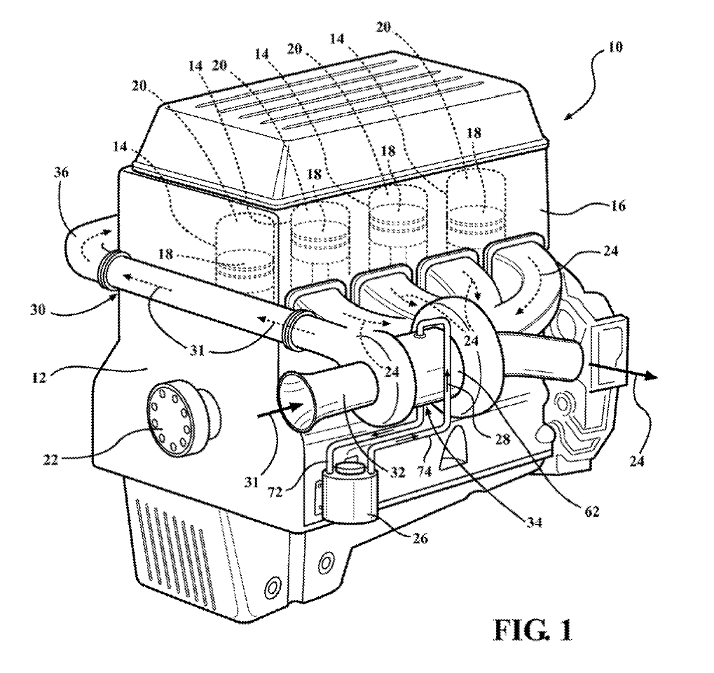

Referring to the drawings wherein like reference numbers correspond to like or similar components throughout the several figures, FIG. 1 illustrates an internal combustion engine 10. The engine 10 includes a cylinder block 12 with a plurality of cylinders 14 arranged therein. As shown, the engine 10 also includes a cylinder head 16. The engine 10 can be of a spark ignition or a compression ignition design. The engine 10 is illustrated as an inline four cylinder arrangement for simplicity. However, it is understood that the present teachings apply to any number of piston-cylinder arrangements and a variety of reciprocating engine configurations including, but not limited to, V-engines, inline engines, and horizontally opposed engines, as well as both overhead cam and cam-in-block configurations. Each cylinder 14 includes a piston 18 configured to reciprocate therein. Combustion chambers 20 are formed within the cylinders 14 between the bottom surface of the cylinder head 16 and the tops of the pistons 18. As known by those skilled in the art, combustion chambers 20 are configured to receive a fuel-air mixture for subsequent combustion therein.

The engine 10 also includes a crankshaft 22 configured to rotate within the cylinder block 12. The crankshaft 22 is rotated by the pistons 18 as a result of a fuel-air mixture being burned in the combustion chambers 20. After the air-fuel mixture is burned inside a specific combustion chamber 20, the reciprocating motion of a particular piston 18 serves to exhaust post-combustion gases 24 from the respective cylinder 14. The engine 10 also includes a fluid pump 26. The fluid pump 26 is configured to supply a lubricating fluid 28, such as engine oil. Accordingly, the fluid pump 26 may supply the lubricating fluid 28 to various bearings, such as that of the crankshaft 22. The fluid pump 26 may be driven directly by the engine 10, or by an electric motor (not shown).

The engine 10 additionally includes an induction system 30 configured to channel airflow 31 from the ambient to the cylinders 14. The induction system 30 includes an intake air duct 32, a turbocharger 34, and an intake manifold 36. Although not shown, the induction system 30 may additionally include an air filter upstream of the turbocharger 34 for removing foreign particles and other airborne debris from the airflow 31. The intake air duct 32 is configured to channel the airflow 31 from the ambient to the turbocharger 34, and the turbocharger is configured to compress (i.e., pressurize) the received airflow 31, and discharge the compressed airflow to the intake manifold 36. The intake manifold 36, in turn, distributes the previously compressed airflow 31 to the cylinders 14 for mixing with an amount of fuel and subsequent combustion of the resultant fuel-air mixture.

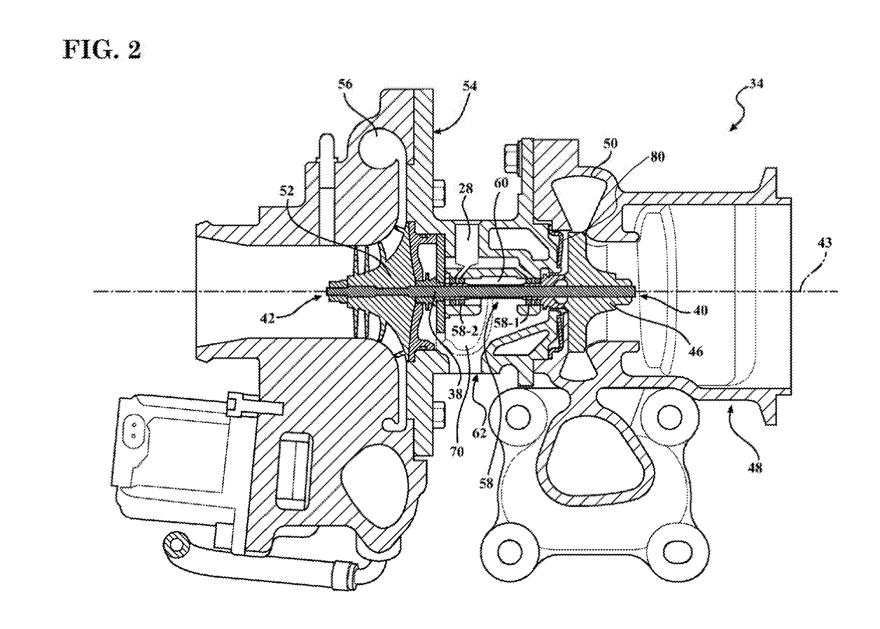

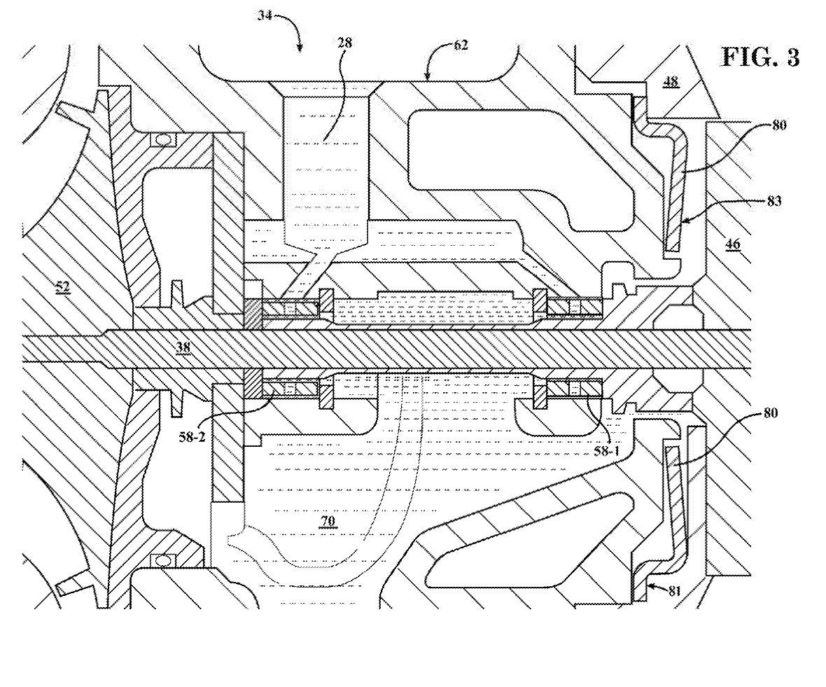

As shown in FIG. 2, the turbocharger 34, represented in simplified form for the sake of clarity, includes a turbine wheel 46 disposed within a turbine housing 48, a compressor wheel 52 disposed within a compressor housing 54, and a shaft 38 passing through a bearing housing 62 and operably connected to the turbine wheel 46 and the compressor wheel 52. The shaft 38 includes a first end 40 and a second end 42, and can be steel, for example. As shown in FIG. 2, and in further detail in FIG. 3, a heat shield 80 is disposed about the shaft 38 in a position between the bearing housing 62 and the turbine wheel 46. The heat shield 80 can be proximate to or contiguous with one or more of the turbine housing 48 and the bearing housing at one or more locations.

The turbine wheel 46 is mounted on the shaft 38 proximate to the first end 40 and configured to be rotated along with the shaft 38 about an axis 43 by post-combustion exhaust gases 24 emitted from the cylinders 14. The turbine wheel 46 is disposed inside the turbine housing 48 that includes a volute or scroll 50. The scroll 50 receives the post-combustion exhaust gases 24 and directs the exhaust gases to the turbine wheel 46. The scroll 50 can be configured to achieve specific performance characteristics, such as efficiency and response, of the turbocharger 34. In operation, the turbine wheel 46 captures kinetic energy from the post-combustion exhaust gases 24, and volumetric restrictions of the gases 24 within the turbine housing 48 convert thermal energy into additional kinetic energy. The heat shield 80 increases the efficiency of the turbine wheel 46 by preventing heat loss and maximizing the conversion of thermal energy into additional kinetic energy. The turbocharger 34 can optionally include a wastegate actuator (not shown) which diverts excess post-combustion exhaust gases 24 away from the turbine wheel 46 in order to limit the rotational speed of the turbine wheel 46.

As further shown in FIG. 2, the compressor wheel 52 is mounted on the shaft 38 proximate to the second end 42. Because the shaft 38 is common to the turbine wheel 46 and the compressor wheel 52, kinetic energy translated from the post-combustion exhaust gases 24 to the turbine wheel 46 imparts rotation to the common shaft 38 which is further communicated to the compressor wheel 52. The variable flow and force of the post-combustion exhaust gases 24 influences the amount of boost pressure that can be imparted to airflow 31 by the compressor wheel 52, and subsequently the amount of oxygen capable of being delivered to cylinders 14, throughout the operating range of the engine 10. The compressor wheel 52 is disposed within the compressor housing 54 that includes a volute or scroll 56. The scroll 56 receives the airflow 31 and directs the airflow to the compressor wheel 52. The scroll 56 can be configured to achieve specific performance characteristics, such as peak airflow and efficiency of the turbocharger 34. The compressor wheel 52 is configured to compress the airflow 31 being received from the ambient for eventual delivery to the cylinders 14. The temperature of airflow 31 is increased during compression by the compressor wheel 52 to the detriment of engine 10 efficiency and performance. During injection into the cylinders 14, a lower airflow 31 temperature is preferred because a higher oxygen density and volumetric fuel to air ratio increases volumetric efficiency the engine 10. Lower airflow 31 temperatures also reduces or eliminates pre-detonation (i.e., “engine knocking”) of fuel prior to an intended spark-induced ignition. Accordingly, turbocharged engines typically include an intercooler (not shown) situated between the compressor housing 54 and the intake manifold 36 for cooling compressed airflow 31 prior to injection into the cylinders 14. The heat shield 80 increases the efficiency of the compressor wheel 52 by preventing or limiting heat transfer from the turbine wheel 46, the turbine housing 48, and/or the post-combustion exhaust gases to the airflow 31 prior to compression. Preventing or limiting heat transfer to the airflow 31 also reduces operational burden imposed on the intercooler, and further increases overall engine 10 efficiency.

With continued reference to FIGS. 2 and 3, the shaft 38 is supported for rotation about the axis 43 via a bearing system 58, such as a hybrid journal bearing system or ball bearing system. The bearing system 58 is disposed within a bore 60 of the bearing housing 62 and is configured to control radial motion and vibrations of the shaft 38. The bearing system 58 can include one or more bearings, such as a first bearing 58-1 and a second bearing 58-2 as shown. While the scope and novelty of the concepts disclosed herein are not constrained to a particular type of bearing system, the heat shields and appurtenant coatings described herein can lend additional benefit to lubricated bearing systems, as will be explained below. As shown in FIGS. 2 and 3, for the purposes of example, the first bearing 58-1 and the second bearing 58-2 are lubricated and cooled by the supply of lubricating fluid 28. Lubricating fluid 28 can be pressurized and supplied via the fluid pump 26 to the bearing housing 62. The bearing housing 62 may be cast from a robust material such as iron in order to provide dimensional stability to the bore 60 under elevated temperatures and loads during operation of the turbocharger 34. The first bearing 58-1 and the second bearing 58-2 can be formed from a relatively soft metal, such as brass or bronze, such that the majority of wear from any contact between the shaft 38 and the bearings, as well as between the housing 62 and the bearings, would be borne by the bearings.

During operation of the turbocharger 34, the pressurized lubricating fluid 28 from the fluid pump 26 is delivered to the bearing housing 62 and directed to the bearing system 58 to lubricate the bearings 58-1, 58-2 and reduce direct contact between the bearings 58-1, 58-2 and the shaft 38, and the bearing 58-2 and the housing 62. Reducing such contact extends useful life of the bearings, reduces frictional losses in the turbocharger 34, reduces noise, vibration, and harshness (NVH), and enhances response of the turbocharger during operation thereof. The bearing housing 62 includes a drain volume 70 for the lubricating fluid 28 that is supplied to the bearing housing from the fluid pump 26. The drain volume 70 is an inner reservoir incorporated into the bearing housing 62, and may have an as-cast shape. With resumed reference to FIG. 1, a discharge passage 72 removes oil from the bearing housing 62 following the lubrication of the bearing system 58 and the oil's collection within the drain volume 70. As also shown in FIG. 1, the discharge passage 72 is in fluid communication with the fluid pump 26 in order to return to the pump the oil from the drain volume 70. A supply passage 74 channels oil from the fluid pump 26 to the bearing housing 62, thus establishing continuous circulation of lubricating oil through the bearing housing during operation of the turbocharger 34. Heat soaking from the turbine housing 48 and turbine wheel 46 into the shaft 38 and proximate components (e.g., bearing housing 62, bearing system 58) can detrimentally raise the temperature high enough to degrade or coke the remaining lubricating fluid 28. The lubricating fluid 28 is particularly susceptible to coking after engine shutdown, for example. Coked lubricating fluid 28 can buildup in and/or plug one or more of the bearing system 58, fluid pump 26, and drain volume 70 such that subsequent lubricating fluid 28 flow lubrication and cooling is inhibited or prevented, and ultimately reduce turbocharger 34 and engine 10 performance. The heat shields provided herein can reduce or prevent lubricating fluid 28 coking.

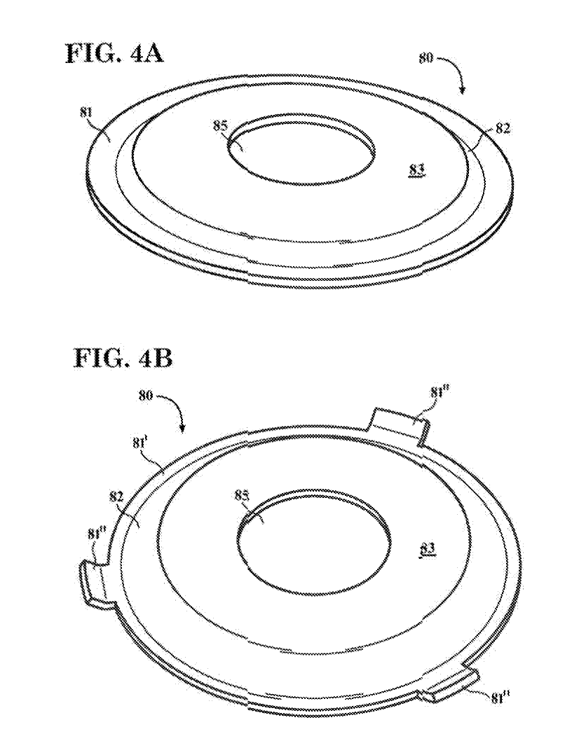

FIGS. 4A-B illustrate perspective view of two embodiments of heat shield 80, such illustrations serving to generally describe the geometry of heat shield 80 and are not to be construed as limiting. In general, heat shield 80 comprises a front face 83 comprising an aperture 85. The aperture 85 is typically centrally located relative to the front face 83, although other positions are practicable as generally dictated by the geometries of appurtenant turbocharger 34 components. The aperture 85 allows for shaft 38 to break the plane of the front face 83 and reach both compressor wheel 52 and turbine wheel 46. Front face 83 accordingly extends radially outward from shaft 38. Perpendicular, convex, and concave orientations of front face 83 relative to shaft 38 are practicable. Heat shield 80 can optionally include a secondary wall 82 and an outer lip 81. Secondary wall 82 can be perpendicular or angled relative to front face 83. Outer lip 81 can comprise a complete circumferential lip, as shown in FIG. 4A, or can comprise one or more discrete tabs. FIG. 4B illustrates outer lip 81 as a combination of a complete circumferential lip 81′ and a plurality of discrete tabs 81″ extending radially outward therefrom. Whether used individually or in combination, circumferential lip 81′ and the one or more discrete tabs 81″ can extend radially outward in perpendicular, convex, or concave orientations relative to shaft 38. FIG. 4A illustrates outer lip 81 in a perpendicular orientation relative to shaft 38. FIG. 4B illustrates circumferential lip 81′ in a perpendicular orientation relative to shaft 38 and the one or more discrete tabs 81″ in a concave orientation relative to shaft 38 and turbine wheel 46. Such a concave orientation of the one or more discrete tabs 81″, or outer lip 81 generally, can provide a friction lock between one or more of the turbine housing 48 and bearing housing 62, for example. Heat shield 80 can serve as a substrate for the compositions described below. In many embodiments, the heat shield 80 is a metallic substrate.

Provided herein are heat shields 80 including thermal barrier coatings (TBC) which impart enhanced heat management to turbochargers 34 and engines 10. Enhanced heat management can include one or more of increased heat retention by the turbine portion (e.g., turbine wheel 46 and turbine housing 48) of a turbocharger 34, reduced or eliminated heat transfer to the compressor portion (e.g., compressor wheel 52 and compressor housing 54) of a turbocharger 34, reduced or eliminated heat transfer to the bearing portion (e.g., bearing system 58 and bearing housing 62) of a turbocharger 34, and reduced oil coking within the turbocharger. TBCs can be applied to all faces of heat shields. In order to save cost, weight, and/or space, TBCs can alternatively be applied selectively to less than all faces of heat shields, such as front face 86 of heat shield 80. The heat shields 80 comprising TBCs increase the efficiency of the turbine wheel 46 by limiting or preventing heat loss from the turbine housing 48. The heat shields 80 comprising TBCs increase the efficiency of the compressor wheel 52 by preventing or limiting heat transfer from the turbine wheel 46, the turbine housing 48, and/or the post-combustion exhaust gases to the airflow 31 prior to compression by the compressor wheel 52. Preventing or limiting heat transfer to the airflow 31 also reduces operational burden imposed on an intercooler, and further increases overall engine 10 efficiency.

A TBC generally includes three layers: a bond coat layer, an interfacial layer, and a ceramic layer. The bond coat layer can be applied directly to the heat shield 80. A TBC can have a total thickness of at least about 100 μm. A TBC can have a total thickness of up to about 500 μm, or greater than 500 μm. The thickness of the TBC can be determined based upon the thermal conductivity of the TBC, and/or space constraints within a turbocharger 34, for example.

The heat shield 80 can comprise various materials such as steel and stainless steel (e.g., 308 SS austenite). The bond coat is a nickel-based metallic material, and can comprise an aluminum content of at least about 4% aluminum, at least about 5% aluminum, at least about 6% aluminum, at least about 7% aluminum, or at least about 8% aluminum. Unless as otherwise specified, percentages refer to a weight percent. The bond coat can comprise about 4% aluminum to about 9% aluminum, about 4.5% aluminum to about 8.5% aluminum, or about 5% aluminum to about 8% aluminum. In a specific embodiment the bond coat comprises about 5% aluminum. The bond coat can further comprise chromium. The bond coat can comprise about 10% chromium to about 36% chromium, about 15% chromium to about 30% chromium, about 15.5% chromium to about 25.5% chromium, or about 15% chromium to about 25% chromium. In some embodiments the bond coat can comprise up to about 36% chromium, up to about 30% chromium, up to about 25.5% chromium, or up to about 25% chromium. The bond coat can further comprise nickel. The bond coat can comprise about 4% nickel to about 10% nickel, about 5.5% nickel to about 8.5% nickel, or about 7% nickel. In some embodiments, the bond coat comprises an amount of aluminum as specified above, optionally an amount of chromium as specified above, and the balance comprising nickel. The heat shield 80 material can be selected based upon its thermal expansion coefficient relative to the thermal expansion coefficient of the bond coat layer. For example, 308 SS has a thermal expansion coefficient of 17.3×10⁻⁶K⁻¹ and a bond coat comprising 15% chromium, 5% aluminum, and the balance comprising nickel has a thermal expansion coefficient of 18×10⁻⁶K⁻¹.

TBCs can be deposited by electron beam-physical vapor deposition (EB-PVD) and thermal spray process techniques, for example. The bond coat can be deposited by high velocity oxy fuel (HVOF) spraying or plasma spraying (PS), for example. The bond coat can optionally include organics during the deposition phase. Nickel-based bond coat materials comprising one or more of aluminum and chromium, particularly those disclosed herein, can utilize powder or wire feedstocks for the spray deposition process. The feedstock material is injected into a high temperature pressurized flame or plasma, thereafter turning immediately into molten particles via exothermic reactions with surrounding atmosphere due to the high enthalpies of aluminum and/or chromium. These high temperature molten particles impinge to the substrate (e.g., the heat shield) and rapidly solidify with a high quenching rate (e.g., 10̂6 K/s). The coating accumulates by subsequent impingement with the hot particles which allow metallurgical bonds to form with the previously deposited layer by diffusion within a short period time. The bond coat can have high resistance to oxidation, high roughness, and high porosity (e.g., about 4% to about 8% porosity). The bond coat can have a thickness of at least about 15 μm, at least about 20 μm, at least about 25 μm, or at least about 30 μm. The bond coat can have a thickness of up to about 150 μm, or greater than about 150 μm.

The interfacial layer is applied to the bond coat layer, and the ceramic layer is lastly applied to the interfacial layer. The ceramic layer comprises a low thermal conductivity ceramic. Suitable low thermal conductivity can defined as less than about 2 kWm⁻¹K⁻¹. Suitable ceramic materials can include yttria-stabilized zirconia (YSZ, e.g., Y₂O₃—ZrO₂), aluminum oxide (e.g., Al₂O₃), titanium oxide (e.g., TiO₂), gadolinium zirconate (e.g., Gd₂Zr₂O₇), and spinels (MgAl₂O₄). In particular, the ceramic can comprise titanium oxide, spinel, or aluminum oxide. Thermally sprayed aluminum oxide has been found to inherently contain microstructural defects, including voids, porosity (e.g., interlamellar and globular), and microcracks, which are generally considered to be undesirable. However for the applications disclosed herein, such microstructural defects lower the thermal conductivity of aluminum oxide from about 3 kWm⁻¹K⁻¹ to acceptable levels. Therefore the advantageous characteristics of aluminum oxide (e.g., weight) can be utilized without compromising thermal performance.

In some embodiments, the ceramic layer is free from yttria-stabilized zirconia and gadolinium zirconate. The ceramic layer can have high surface roughness. For example, the ceramic layer can have an average surface roughness (Ra) of at least about 9 μm. Additionally or alternatively, the ceramic layer can have a mean roughness depth (Rz) of at least about 50 μm. The ceramic layer can be deposited by EB-PVD or PS, for example. A suitable deposition method is one which imparts low thermal conductivity and high strain tolerance to the deposited ceramic. The ceramic layer can have a thickness of at least about 150 μm. The ceramic layer can have a thickness of up to about 500 μm, or greater than about 500 μm.

The interfacial layer comprises a mixture of the ceramic material from the ceramic layer and the material from the bond coat layer. For example, the interfacial layer can comprise about a 50%/50% blend of bond coat material/ceramic. The interfacial layer can comprise about a 10%/90% to about a 90%/10% blend of bond coat material/ceramic. In one embodiment, wherein the ceramic is YSZ, gadolinium zirconate, or spinel, the interfacial layer can comprise about a 40%/60% to about 60%/40% bondcoat material/ceramic blend. In some embodiments, the interfacial layer can comprise a plurality of blended layers of varying compositions. In embodiments wherein the interfacial layer comprises multiple blended layers, the concentration of the ceramic material in each of the blended layers can increase relative to the other blended layers with increased proximity to the ceramic top coat layer. Additionally or alternatively, in embodiments wherein the interfacial layer comprises multiple blended layers, the concentration of the bond coat material in each of the blended layers can increase relative to the other blended layers with increased proximity to the bond coat layer. In some embodiments, the interfacial layer is free from yttria-stabilized zirconia and gadolinium zirconate.

In one embodiment, wherein the ceramic is aluminum oxide or titanium oxide, the interfacial layer can include a plurality of interfacial subsections. In one embodiment having three interfacial subsections, interfacial subsection 1 can comprise about a 90%/10% to about 70%/30% bondcoat material/ceramic blend, interfacial subsection 2 can comprise about a 40%/60% to about 60%/40% bondcoat material/ceramic blend, and interfacial subsection 3 can comprise about a 10%/90% to about 70%/30% bondcoat material/ceramic blend. A larger thermal expansion disparity between the bond coat layer and ceramic layer can require more interfacial subsections. The interfacial layer can be at least about 10 μm. An interfacial subsection can be at least about 10 μm. In some embodiments, the ceramic layer can comprise a small amount of bondcoat layer material, such as less than about 5% bondcoat material.

The turbocharger heat shield TBCs provided herein exhibit superior adhesion and heat shielding capabilities under a variety of conditions, including physical deformation and thermal shock. Such characteristics are advantageous to the use of the disclosed TBCs with turbocharger heat shields, wherein previously only metallic heat shields were used. In particular, the TBCs provided herein exhibit temperature-dependent heat conductivity. In particular, the TBCs exhibit decreasing thermal conductivity with increasing temperature. Further, the ceramic compositions lend enhanced heat shielding capabilities and weight saving advantages simultaneously.

### Example 1

A TBC was applied to a 308 SS heat shield using atmospheric plasma spraying using an F4 torch and an 8 mm nozzle. The bondcoat prior to deposition comprised 15.5-21.5% chromium, 4-8% aluminum, 4% organics, and the balance nickel. The organics were consumed during deposition. The process conditions comprised: feed rate=15.0 rpm^{˜}30 g/min, argon=47.5 slpm, current=550 amps, hydrogen=6.0 slpm, and stand-off distance=100 mm. The interfacial layer comprised a 50%/50% blend of the bondcoat material and YSZ (10-75 μm particle size). The process conditions comprised: feed rate=17.0 rpm^{˜}30 g/min, argon=47.5 slpm, current=550 amps, hydrogen=6.0 slpm, and stand-off distance=100 mm. The ceramic layer comprised a 95%/5% blend of YSZ and bondcoat material. The process conditions comprised: feed rate=19.0 rpm^{˜}30 g/min, argon=47.5 slpm, current=550 amps, hydrogen=6.0 slpm, and stand-off distance=100 mm.

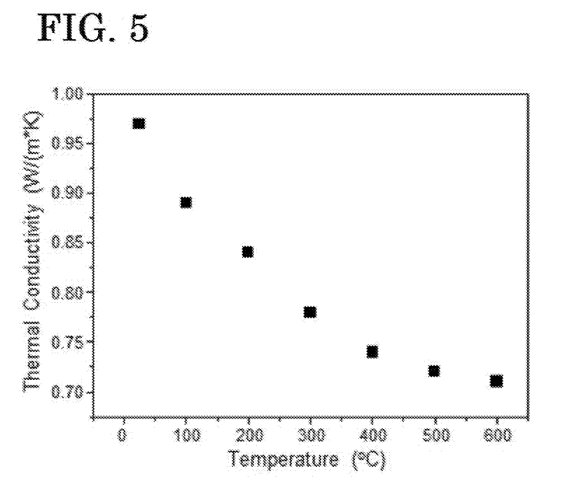

Two trials were run with the above conditions. The total thickness of the TBCs were 344.39 μm and 338.41, with an average sample Ra value of 9.18 μm and an average sample Rz value of 51.03. The samples survived an extreme thermal shock test (heating at 980° C. for 30 minutes with subsequent water quench) without any noticeable peeling or cracks when viewed under 10× magnification. This indicates superior adhesion. No peeling or delamination of the material was observed after the heat shield substrate was bent to 90 degrees subject to ASTM B489 test specifications, further indicating superior adhesion. FIG. 5 illustrates thermal conductivity data for one of the two TBC trials. It can be observed that the TBCs exhibit decreasing thermal conductivity with increasing temperature.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A turbocharger heat shield thermal barrier coating, the coating comprising:
a metallic bond coat;
an interfacial layer contacting the bond coat; and
a ceramic top coat contacting the interfacial layer;
wherein the bond coat is applied to a metallic turbocharger heat shield.

2. The thermal barrier coating of claim 1, wherein the turbocharger heat shield comprises stainless steel.

3. The thermal barrier coating of claim 1, wherein the bond coat comprises nickel.

4. The thermal barrier coating of claim 3, wherein the bond coat comprises about 4% aluminum to about 9% aluminum.

5. The thermal barrier coating of claim 3, wherein the bond coat comprises up to about 36% chromium.

6. The thermal barrier coating of claim 3, wherein the bond coat comprises aluminum, chromium, and nickel.

7. The thermal barrier coating of claim 3, wherein the bond coat comprises at least about 4% aluminum.

8. The thermal barrier coating of claim 3, wherein the bond coat comprises at least about 4% aluminum, about 10% chromium to about 36% chromium, and the balance comprising nickel.

9. The thermal barrier coating of claim 1, wherein the interfacial layer comprises a mixture of the ceramic material from the ceramic layer and the bond coat material from the bond coat layer.

10. The thermal barrier coating of claim 9, wherein the interfacial layer comprise a plurality of blended layers.

11. The thermal barrier coating of claim 10, wherein the concentration of the ceramic material in each of the blended layers increases relative to the other blended layers with increased proximity to the ceramic top coat layer.

12. The thermal barrier coating of claim 10, wherein the concentration of the bond coat material in each of the blended layers increases relative to the other blended layers with increased proximity to the bond coat layer.

13. The thermal barrier coating of claim 1, wherein the ceramic top coat comprises one or more of yttria-stabilized zirconia, aluminum oxide, titanium oxide, gadolinium zirconate, and spinel.

14. The thermal barrier coating of claim 1, wherein the ceramic top coat comprises one or more of aluminum oxide, titanium oxide, and spinel.

15. The thermal barrier coating of claim 1, wherein the bond coat has a thickness of at least about 15 μm.

16. The thermal barrier coating of claim 1, wherein the interfacial layer has a thickness of at least about 10 μm.

17. The thermal barrier coating of claim 1, wherein the ceramic top coat has a thickness of at least about 150 μm.

18. The thermal barrier coating of claim 1, wherein the coating has a total thickness of at least about 100 μm.

19. A turbocharger heat shield, comprising:
a metallic substrate having a front face including an aperture;
a bond coat applied to the metallic substrate, wherein the bond coat includes aluminum and nickel;
an interfacial layer contacting the bond coat; and
a ceramic top coat contacting the interfacial layer,
wherein one or more of the interfacial layer and the ceramic top coat comprise aluminum oxide, titanium oxide, spinel, and combinations thereof.

20. The turbocharger heat shield of claim 19, wherein one or more of the interfacial layer and the ceramic top coat are free from yttria-stabilized zirconia and gadolinium zirconate.
